(19) United States
(12) Patent Application Publication
(10) Pub. No.: US 2002/0101424 A1
(43) Pub. Date: Aug. 1, 2002

(54) Method of testing graphic accelerator in DOS mode

(76) Inventors: Bin Yuan, Tienchin (CN); Tong S. Chen, Taipei (TW); Kuang Shin Lin, Taipei (TW)

Correspondence Address: BIRCH STEWART KOLASCH & BIRCH, PO BOX 747, FALLS CHURCH, VA, 22040-0747, US

(21) Appl. No.: 09/742,404

(22) Filed: Dec. 22, 2000

(51) Int. Cl. G06F 15/16

(52) U.S. Cl. 345/503

(57) ABSTRACT

A method of testing a graphic accelerator in DOS mode comprises the steps of: setting the calculator system in DOS 32 bit full address mode, but not in the protect mode; mapping the RAM of the graphic accelerator to a predetermined location somewhere in the 0-4G space of the system RAM; preparing a test software such as BitBlt, H/W cursor, 3D Texture; preparing an original pattern, generally a ready bitmap; copying the pattern from the system RAM to the video RAM of the graphic accelerator, verifying the result, and if errors occur, dealing with the errors; copying the pattern from the video RAM to the video RAM, verifying the result, and if errors occur, dealing with the errors; performing a test of color image to monochrome image conversion, verifying the result, and if errors occur, dealing with the errors; and restoring the normal 16 bit address mode VGA mode.

### BACKGROUND OF THE INVENTION

1. Field of the Invention

The present invention relates to a method of testing a graphic accelerator. More particularly, it relates to a method of testing a graphic accelerator in DOS mode.

2. Description of the Related Art

Graphic accelerators used in laptop computers are getting more and more complicated. In U.S. Pat. No. 5,990,902, a video controller in a graphic accelerators suitable for use in three dimensional graphics and texture mapping is disclosed. It is necessary to test a graphic accelerator during the manufacturing process in order to ensure product quality. There are various types of graphic accelerators and each type has various functions. However, there is no full test on all the functions of a graphic accelerator. A simple evaluation with no strict scientific test can't judge whether a graphic accelerator functions well on each performance, so the conclusion might be in error. Therefore, test methods at present can't ensure the accelerating function of graphic accelerators in a laptop computer is perfect.

The present invention provides a method of testing a graphic accelerator in DOS mode. A graphic accelerator is capable of processing image data at high speeds. The following purposes can be achieved by the present invention.

1. The test platform is DOS, which is an economical and practical platform with low test cost.

2. Via the technique, various accelerating functions provided by graphic accelerators can be efficiently and fully tested. The defect that the test results don't fully reflect all the functions of graphic accelerators can be avoided.

3. The method provided by the present invention is easy, feasible and timesaving, therefore suitable for use on the production line.

### SUMMARY OF THE PRESENT INVENTION

The method of testing graphic accelerators in DOS mode according to the present invention performs an overall test on various accelerating functions of a graphic accelerator in 32 bit to full address mode by using input/output(I/O) mapping.

A method of testing a graphic accelerator in DOS mode according to the present invention, comprises the steps of: setting the calculating system in DOS 32 bit full address mode, but not in the protect mode; mapping the RAM of the graphic accelerator to a predetermined location somewhere in the 0-4G space of the system RAM; preparing test software such as BitBlt, H/W cursor, 3D Texture; preparing an original pattern for test use, generally a ready bitmap; copying the pattern from the system RAM to the video RAM of the graphic accelerator, verifying the result, and if errors occur, dealing with the errors; copying the pattern from the video RAM of the graphic accelerator to the video RAM of the graphic accelerator, verifying the result, and if errors occur, dealing with the errors; performing a test of color image to monochrome image conversion, and if errors occur, dealing with the errors; and restoring the normal 16 bit address mode/ VGA mode.

### BRIEF DESCRIPTIONS OF THE DRAWINGS

The following detailed description, given by way of examples and not intended to limit the invention solely to the embodiment described herein, will best be understood in conjunction with the accompanying drawings, in which:

FIG. 1 is a flowchart illustrating a test procedure in an embodiment according to the present invention;

FIG. 2 is a flowchart illustrating a procedure of entering DOS 32 bit address mode;

FIG. 3 is a flowchart illustrating a procedure of restoring DOS 16 bit address mode;

FIG. 4 is a flowchart illustrating a procedure of entering VGA Aperture mode; and

FIG. 5 is a flowchart illustrating the procedure of copying from VRAM to VRAM and verifying the result.

### DESCRIPTIONS OF THE PREFERRED EMBODIMENTS

A method of testing a graphic accelerator in DOS mode according to the present invention is applied to semi-manufactured products. Therefore, the semi-manufactured products with defects can be fixed before assembly, so as to save cost.

### Embodiment

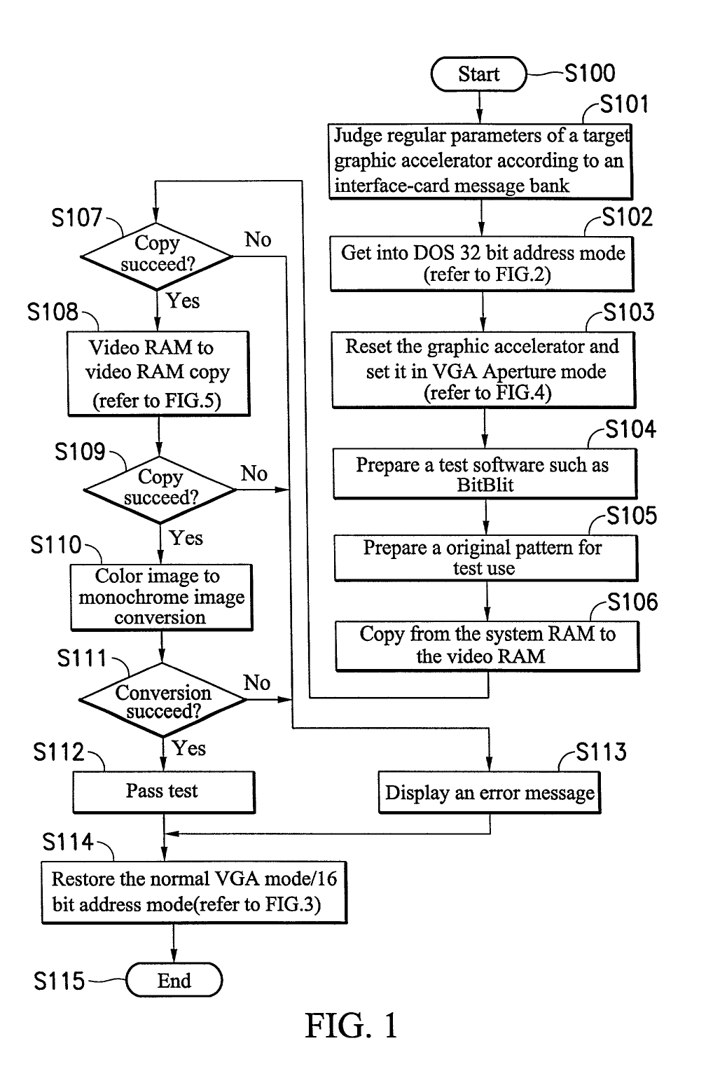

Refer to FIG. 1, which provides a method of testing a graphic accelerator by using BitBlt (Bit Block Transport). The method comprises the following steps.

First, at step S101 the regular parameters of a target graphic accelerator are judged according to an interface-card message bank while the regular parameters are the bases of the test. The parameters of a target graphic accelerator can be further described at this step so as to perform the following test on various graphic accelerators.

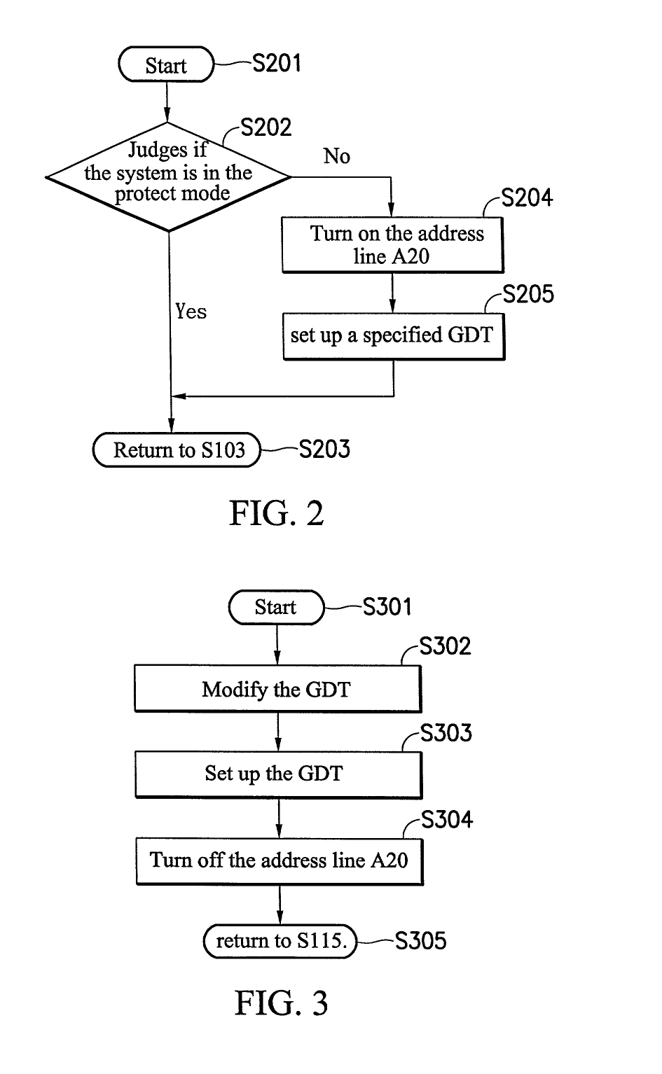

At step S102, get into DOS 32 bit address mode, but not the protect mode. Typically DOS address mode is 16 bit mode. Through a specified way calculating systems can get into 32 bit address mode, which is different from the protect mode. In the protect mode, the CPU distinguishes the privileged class from the user class. The processing procedure at this step is as follows (refer to FIG. 2).

Step S202 judges if the system is in the protect mode. If so, go to step S203, returning to step S103. If not, execute step S204, turning on the address line A20, which is actuated by using a machine code. At step S205, set up a specified GDT(Global Descriptor Table). Then, go to step S203, returning to step S103.

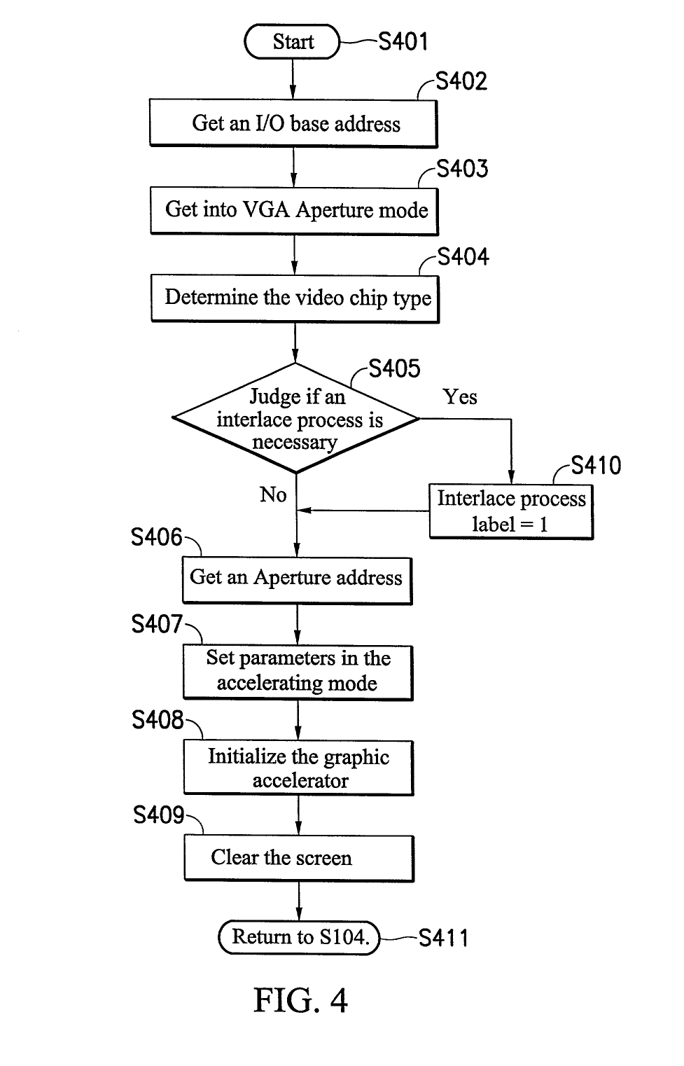

At step S103, the graphic accelerator is reset and then get into VGA Aperture mode. All the current graphic accelerators have the operation mode. In this mode, the RAM of the graphic accelerator is mapped to a predetermined location somewhere in the 0-4G space of the system RAM and usually successive address spaces are occupied. Therefore, the graphic accelerator can be flexibly operated. The processing procedure at this step is as follows (refer to FIG. 4).

At step S402, get an I/O base address. At step S403, get into VGA Aperture mode. At step S404, determine the video chip type. At step S405, judge if an interlace process is necessary. If so, go to step S410, set the interlace process label as “1”, and then move to step S406. If not, directly execute step S406 to get an Aperture address. At step S407, set the parameters for the graphic accelerator in the accelerating mode. At step S408, initialize the graphic accelerator and set the necessary parameters depending on the desired functions. At step S409, clear the screen to prevent unexpected codes appearing on the screen. Then, at step S411 return to step S104.

At step S104 prepare test software such as BitBlit, H/W cursor, and 3D Texture. BitBlit is used in the following steps.

At step S105, prepare an original pattern, generally a ready bitmap. If the bitmap is a 256-color bitmap, it is also necessary to set the VGA Palette.

At step S106, copy the bitmap from the system RAM to the video RAM and verify the result. If errors occur, deal with the errors.

At step S107, judge whether it succeeds in copying from the system RAM to the video RAM. If so, move to step S108, otherwise go to step S113 displaying an error message.

At step S108, copy from the video RAM to the video RAM and verify the result. If errors occur, deal with the errors.

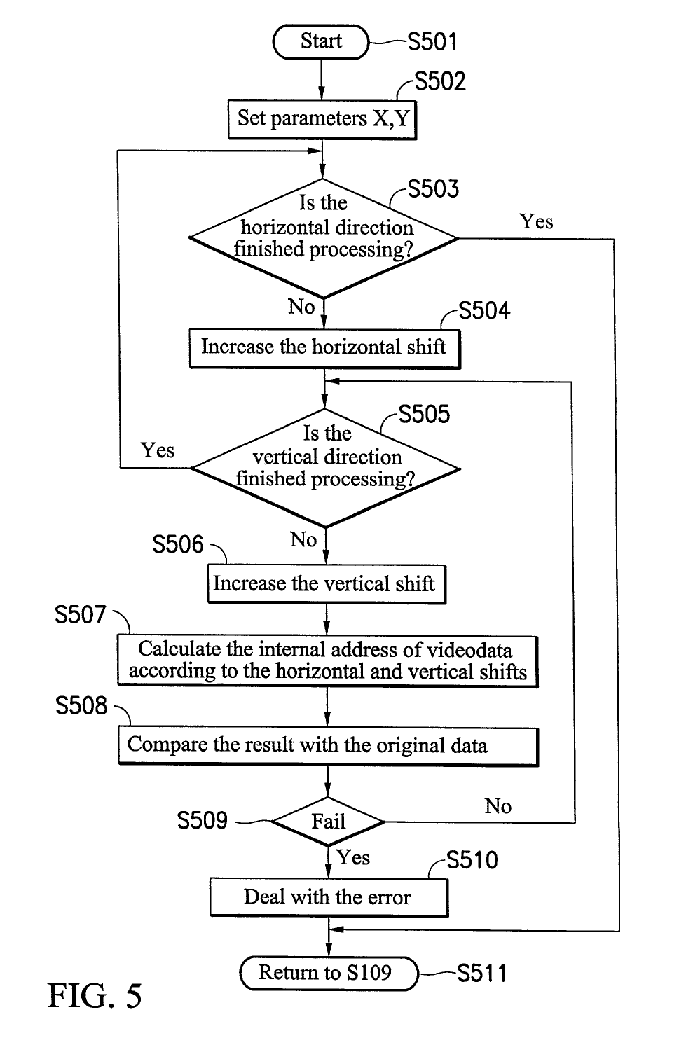

The processing procedure at this step is as follows (refer to FIG. 5).

At step S502, set the parameters X,Y. At step S503, judge whether the horizontal direction is finished processing. If so, go to step S511 returning to step S109, otherwise move to step S504 increasing the horizontal shift. At step S505, judge whether the vertical direction is finished processing. If so, return to step S503, otherwise move to step S506 increasing the vertical shift. At step S507, calculate the internal address of video data according to the horizontal and vertical shifts. At step S508, compare the result with the original data. If they are the same, return to step S505, otherwise go to step S510 dealing with the error. At step 511, return to step S109.

At step S109, judge whether it succeeds in copying from the video RAM to the video RAM. If so, go to step S110; otherwise go to step S113 displaying an error message.

At step S110, perform a test of color image to monochrome image conversion. Substantially same as the test above, the step tests a little more on graphically accelerating function.

At step S114, restore the normal address mode/16 bit address mode, cancel VGA Aperture mode, and restore normal VGA mode. The processing procedure at this step is as follows (refer to FIG. 3).

At step S302, modify the GDT(Global Descriptor Table) At step S303, set up the GDT. At step S304, turn off the address line A20. Last, at step S305, return to step S115.

At step S115, a test cycle is completed.

While the invention has been described with reference to a preferred embodiment, the description is not intended to be construed in a limiting sense. Various modifications of the illustrative embodiments, as well as other embodiments of the invention, will be apparent to those persons skilled in the art upon reference to this description. It is therefore contemplated that the appended claims will cover any such modifications or embodiments as may fall within the scope of the invention defined by the following claims and their equivalents.

What is claimed is:

1. A method of testing a graphic accelerator in DOS mode, which judges regular parameters of a target graphic accelerator according to an interface-card message bank, comprising the steps of:
(a) setting a calculating system in DOS full address mode;
(b) mapping the video RAM of the graphic accelerator to a predetermined location in a system RAM;
(c) copying a pattern from the system RAM to the video RAM of the graphic accelerator and verifying the result; if there is any error message with the parameters, moving to the step (f); and if it succeeds, moving to the next step;
(e) performing a test of color image to monochrome image conversion and verifying the result; if it succeeds, moving to the step (g); and if the parameters show any error message, moving to the next step;
(f) displaying an error message; and
(g) restoring the normal address mode/ VGA (video graphics array)mode.

2. The method as claimed in claim 1, wherein the step (a) is not in the protect mode.

3. The method as claimed in claim 2, wherein at the step (b) the graphic accelerator is in VGA Aperture mode.

4. The method as claimed in claim 1, wherein at the steps (c), (d), (e) the test software is Bit Block Transport.

5. The method as claimed in claim 1, wherein at the steps (c), (d), (e) the test software is H/W cursor.

6. The method as claimed in claim 1, wherein in the steps (C), (d), (e) the test software is 3D Texture.

7. The method as claimed in claim 1, wherein at the steps (c), (d), (e) the test pattern is a ready bitmap.
